(19) United States
(12) Patent Application Publication
(10) Pub. No.: US 2025/0308244 A1
(43) Pub. Date: Oct. 2, 2025

(54) VEHICLE MANAGEMENT SYSTEM AND VEHICLE MANAGEMENT METHOD

(71) Applicant: TOYOTA JIDOSHA KABUSHIKI KAISHA, Toyota-shi (JP)

(72) Inventors: Daisuke KAKUMA, Susono-shi (JP); Hiroya CHIBA, Fuji-shi (JP)

(73) Assignee: TOYOTA JIDOSHA KABUSHIKI KAISHA, Toyota-shi (JP)

(21) Appl. No.: 19/045,988

(22) Filed: Feb. 5, 2025

(30) Foreign Application Priority Data
Apr. 2, 2024 (JP) 2024-059754

(51) Int. Cl. G06V 20/54; G06T 7/73; G06V 10/70

(52) U.S. Cl. CPC G06V 20/54; G06T 7/75; G06V 10/87; G06V 2201/07; G06V 2201/08

(57) ABSTRACT

A vehicle management system manages a vehicle in a predetermined area. The vehicle management system has a machine learning model for estimating a position of a vehicle shown in an image. The vehicle management system acquires a target-specialized parameter from a parameter providing apparatus, the target-specialized parameter being a parameter of the machine learning model trained with a focus on a category of a target vehicle. The vehicle management system apples the target-specialized parameter to the machine learning model to acquire a target-specialized machine learning model specialized in the category of the target vehicle. The vehicle management system acquires an image captured by a camera installed in the predetermined area and showing the target vehicle. The vehicle management system estimates a position of the target vehicle based on the image and the target-specialized machine learning model.

### CROSS-REFERENCES TO RELATED APPLICATION

The present disclosure claims priority to Japanese Patent Application No. 2024-059754, filed on Apr. 2, 2024, the contents of which application are incorporated herein by reference in their entirety.

### TECHNICAL FIELD

The present disclosure relates to a technique for managing a vehicle in a predetermined area. The present disclosure also relates to a technique for estimating a position of a vehicle based on an image captured by a camera.

### BACKGROUND ART

Patent Literature 1 discloses a travel assist control device that assists traveling of a control target vehicle. The travel assist control device grasps a position of the control target vehicle based on an image information acquired by a camera. At this time, the travel assist control device acquires vehicle identification information (vehicle dimensions, a wheelbase length, a tread width, and the like) from the control target vehicle. Then, the travel assist control device grasps the position of the control target vehicle based on the image information by referring to the acquired vehicle identification information.

### LIST OF RELATED ART

Patent Literature 1: Japanese Laid-Open Patent Application No. JP-2016-57677

### SUMMARY

When estimating a position of a vehicle shown in an image captured by a camera, it is conceivable to use a machine learning model in order to increase accuracy of the position estimation. However, it takes a lot of work and a huge cost to create a machine learning model that can meet all vehicle types with sufficient accuracy. In addition, it is necessary to update such the machine learning model each time a new vehicle type is released.

A first aspect is directed to a vehicle management system that manages a vehicle in a predetermined area.

The vehicle management system includes:
one or more processors; and
a storage configured to store a machine learning model for estimating a position of a vehicle shown in an image.

The one or more processors acquire a target-specialized parameter from a parameter providing apparatus, the target-specialized parameter being a parameter of the machine learning model trained with a focus on a category of a target vehicle.

The one or more processors apply the target-specialized parameter to the machine learning model stored in the storage to acquire a target-specialized machine learning model specialized in the category of the target vehicle.

The one or more processors acquire an image captured by a camera installed in the predetermined area and showing the target vehicle.

The one or more processors estimate a position of the target vehicle based on the image and the target-specialized machine learning model.

A second aspect relates to a vehicle management method for managing a vehicle in a predetermined area by a computer.

The vehicle management method includes:
acquiring a machine learning model for estimating a position of a vehicle shown in an image;
acquiring a target-specialized parameter from a parameter providing apparatus, the target-specialized parameter being a parameter of the machine learning model trained with a focus on a category of a target vehicle;
applying the target-specialized parameter to the machine learning model to acquire a target-specialized machine learning model specialized in the category of the target vehicle;
acquiring an image captured by a camera installed in the predetermined area and showing the target vehicle; and
estimating a position of the target vehicle based on the image and the target-specialized machine learning model.

According to the present disclosure, the target-specialized parameter specialized in the category of the target vehicle is acquired from the parameter providing apparatus. Applying the target-specialized parameter to the machine learning model makes it possible to acquire the target-specialized machine learning model specialized in the category of the target vehicle. Then, the position of the target vehicle is estimated based on the target-specialized machine learning model. It is thus possible to estimate the position of the target vehicle with high accuracy. Further, according to the present disclosure, a general-purpose machine learning model that can meet all categories is not necessary. Since it is not necessary to generate or update a general-purpose machine learning model that can meet all categories, works and costs are significantly reduced.

### BRIEF DESCRIPTION OF DRAWINGS

FIG. 1 is a conceptual diagram for explaining an overview of a vehicle management system;

FIG. 2 is a conceptual diagram for explaining an example of vehicle management in a predetermined area;

FIG. 3 is a conceptual diagram for explaining a basic configuration related to a vehicle position estimation process performed by a vehicle management system;

FIG. 4 is a conceptual diagram for explaining a comparative example;

FIG. 5 is a block diagram for explaining a vehicle position estimation process using a target-specialized machine learning model;

FIG. 6 is a conceptual diagram for explaining a target-specialized machine learning model;

FIG. 7 is a block diagram for explaining a first example of a parameter providing apparatus;

FIG. 8 is a block diagram for explaining a second example of a parameter providing apparatus;

FIG. 9 is a block diagram for explaining generation of a target-specialized parameter; and

FIG. 10 is a conceptual diagram for explaining a concreted example of vehicle management by a vehicle management system.

### DETAILED DESCRIPTION

Embodiments of the present disclosure will be described with reference to the accompanying drawings.

### 1. Vehicle Management System

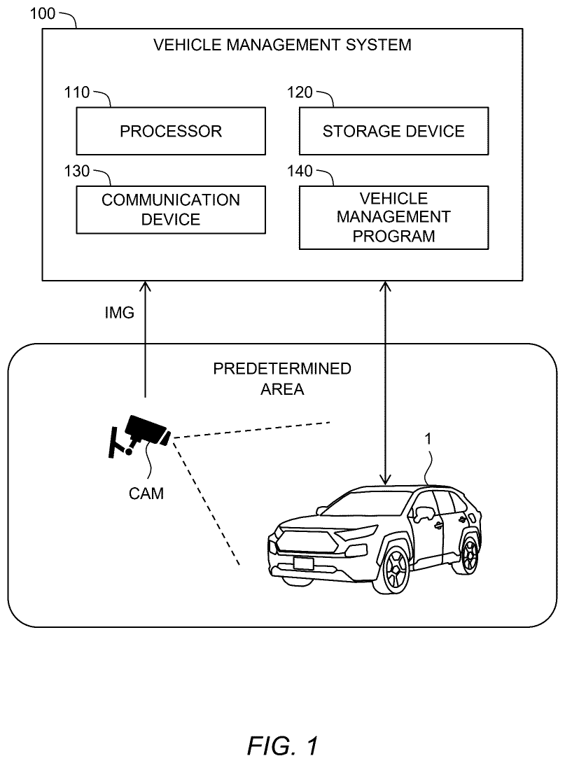

FIG. 1 is a conceptual diagram for explaining an overview of a vehicle management system 100 according to the present embodiment. The vehicle management system 100 manages a vehicle 1 in a predetermined area. Examples of the predetermined area include a parking lot, a factory, a site of a facility, a city (a smart city), and the like. The vehicle 1 may be an autonomous driving vehicle. The vehicle management system 100 includes, for example, a management server. The vehicle management system 100 may include a plurality of nodes that perform distributed processing.

According to the present embodiment, one or more infrastructure cameras CAM installed in the predetermined area are used for the management of the vehicle 1. The infrastructure camera CAM is installed so as to be able to capture at least a situation of the predetermined area. The infrastructure camera CAM images the predetermined area and acquires an image IMG indicating the situation of the predetermined area.

The vehicle management system 100 communicates with the infrastructure camera CAM to acquire the image IMG captured (taken) by the infrastructure camera CAM. The vehicle management system 100 detects the vehicle 1 shown in the image IMG by analyzing the image IMG. Moreover, the vehicle management system 100 estimates a position of the vehicle 1 shown in the image IMG. The vehicle position estimation process will be described in detail later. Further, the vehicle management system 100 manages the vehicle 1 in the predetermined area based on the estimated position of the vehicle 1. The vehicle management system 100 may manage traveling of the vehicle 1 in the predetermined area based on the estimated position of the vehicle 1.

The vehicle management system 100 includes one or more processors 110 (hereinafter, simply referred to as a processor 110), one or more storage devices 120 (hereinafter, simply referred to as a storage device 120), and a communication device 130. The processor 110 executes a variety of processing. Examples of the processor 110 include a general-purpose processor, a special-purpose processor, a central processing unit (CPU), a graphics processing unit (GPU), an application specific integrated circuit (ASIC), a field-programmable gate array (FPGA), an integrated circuit, and/or combinations thereof. The processor 110 may be referred to as “processing circuitry”. The storage device 120 stores a variety of information. Examples of the storage device 120 include a hard disk drive (HDD), a solid state drive (SSD), a volatile memory, a nonvolatile memory, and the like. The communication device 130 communicates with the outside via a communication network. For example, the communication device 130 communicates with the infrastructure camera CAM. The communication device 130 may communicate with the vehicle 1.

A vehicle management program 140 is a computer program for managing the vehicle 1 in the predetermined area. The functions of the vehicle management system 100 may be implemented by a cooperation of the processor 110 executing the vehicle management program 140 and the storage device 120. The vehicle management program 140 is stored in the storage device 120. Alternatively, the vehicle management program 140 may be recorded on a non-transitory computer-readable recording medium.

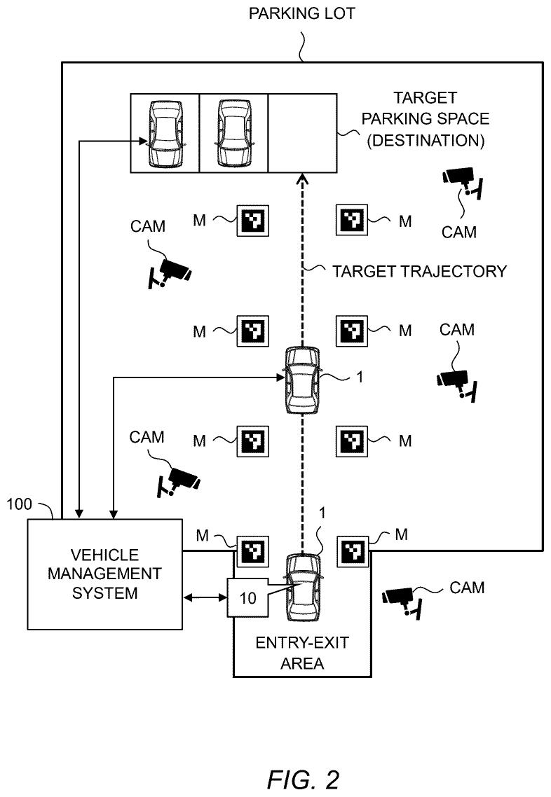

FIG. 2 is a conceptual diagram for explaining an example of vehicle management in the predetermined area. In the example shown in FIG. 2, the predetermined area is a parking lot. The parking lot provides an automated valet parking (AVP) service. The vehicle 1 supports the automated valet parking service.

An in-vehicle system 10 is mounted on the vehicle 1 and controls the vehicle 1. More specifically, the in-vehicle system 10 recognizes a situation around the vehicle 1 by using a recognition sensor (for example, a camera) mounted on the vehicle 1. The in-vehicle system 10 makes the vehicle 1 travel while recognizing the situation around the vehicle 1. A plurality of markers M (landmarks) may be arranged in the parking lot. The in-vehicle device 10 may perform localization processing that recognizes the marker M by using the in-vehicle camera and estimates a position of the vehicle 1 based on a result of the recognition of the marker M. The in-vehicle device 10 may make the vehicle 1 travel automatically in the parking lot based on the estimated vehicle position.

The vehicle management system 100 manages the automated valet parking and each vehicle 1 in the parking lot (i.e., the predetermined area). The vehicle management system 100 is able to communicate with the in-vehicle device 10 of each vehicle 1 in the parking lot. One or more infrastructure cameras CAM are installed in the parking lot. The vehicle management system 100 acquires one or more images IMG captured by the one or more infrastructure cameras CAM. The vehicle management system 100 may estimate a position of the vehicle 1 in the parking lot based on the image IMG. The vehicle management system 100 may manage each vehicle 1 based on the position of the each vehicle 1. The vehicle management system 100 may remotely operate the vehicle 1 in the parking lot. For example, the vehicle management system 100 may remotely operate the vehicle 1 so as to reach the destination based on the position of the vehicle 1.

An example of an entry (check-in) process is as follows. The vehicle 1 stops at a predetermined entry area. The vehicle management system 100 authenticates the vehicle 1. In addition, the vehicle management system 100 allocates an available parking space to the vehicle 1. The allocated available parking space is a target parking space (i.e., a destination) for the vehicle 1 at the time of the entry. Further, the vehicle management system 100 estimates a current position of the vehicle 1 and sets a target trajectory (target route) from the current position of the vehicle 1 to the target parking space. The vehicle management system 100 issues an entry instruction to the in-vehicle device 10. In response to the entry instruction, the in-vehicle device 10 makes the vehicle 1 travel to the target parking space in accordance with the target trajectory. Alternatively, the vehicle management system 100 may cause the vehicle 1 to travel to the target parking space in accordance with the target trajectory.

An example of an exit (check-out) process is as follows. A destination at the time of exit is a specified exit area. As in the case of the entry, a target trajectory from the current position of the vehicle 1 to the exit area is set. The vehicle management system 100 issues an exit instruction to the in-vehicle device 10. In response to the exit instruction, the in-vehicle device 10 makes the vehicle 1 travel to the exit area in accordance with the target trajectory. Alternatively, the vehicle management system 100 may cause the vehicle 1 to travel to the exit area in accordance with the target trajectory.

### 2. Vehicle Position Estimation Process

### 2-1. Basic Configuration

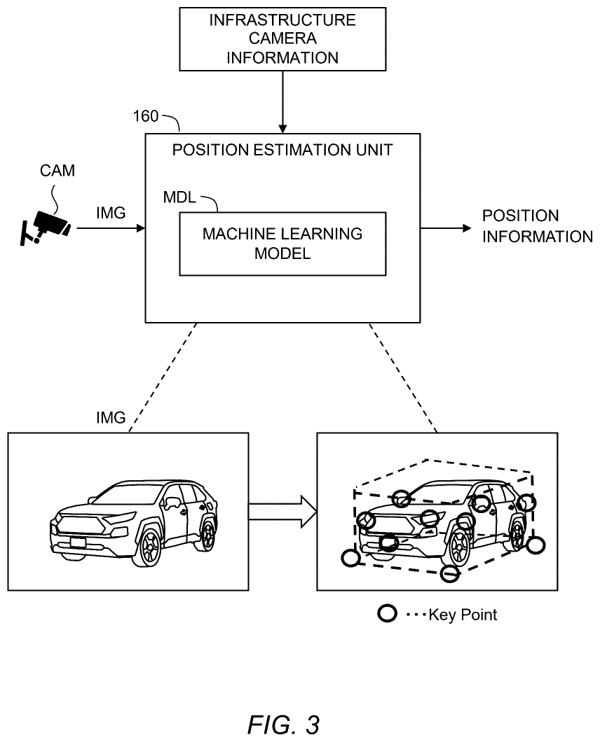

FIG. 3 is a conceptual diagram for explaining a basic configuration related to a vehicle position estimation process performed by the vehicle management system 100. The vehicle management system 100 includes a position estimation unit 160 as a functional block. The position estimation unit 160 may be implemented by a cooperation of the processor 110 and the storage device 120. Information necessary for the processing is stored in the storage device 120.

The position estimation unit 160 acquires the image IMG captured (taken) by the infrastructure camera CAM. Here, a case where a certain vehicle 1 is shown in the image IMG is considered. The vehicle 1 shown in the image IMG is the target of position estimation. For convenience, the vehicle 1 shown in the image IMG is hereinafter referred to as a target vehicle 1-X. The position estimation unit 160 detects the target vehicle 1-X shown in the image IMG. For example, a machine learning model trained to detect a target and a class from the image IMG is used for the vehicle detection process. The position estimation unit 160 may recognize a vehicle type of the target vehicle 1-X. A bounding box may be added around the detected target vehicle 1-X.

The position estimation unit 160 extracts feature points of the target vehicle 1-X detected in the image IMG. The feature points may be referred to as key points. Examples of the feature points include components of the vehicle 1 such as a tire, a headlight, a license plate, a side mirror, a door, a window, a decorative components and the like. The feature points may include a ground contact point of the tire, corners of the bounding box, and the like. The position estimation unit 160 acquires a position (coordinates) and a type of each feature point in the image IMG. The position estimation unit 160 may acquire a size of each feature point in the image IMG. Feature point information is information on the feature points extracted in the image IMG. For example, the feature point information indicates the position and the type of each of a plurality of feature points in the image IMG, a positional relationship between the plurality of feature points, and the like.

Further, the position estimation unit 160 estimates a position (coordinates) and a direction of the vehicle 1 in the image IMG based on the feature point information. The position of the vehicle 1 in the image IMG is a position of a representative point of the vehicle 1. The representative point is not limited in particular. For example, the representative point may be a central point of the vehicle 1.

A machine learning model MDL is used for the feature point extraction process and the position estimation process in the position estimation unit 160. That is, the position estimation unit 160 includes the machine learning model MDL for estimating the position of the target vehicle 1-X shown in the image IMG. The machine learning model MDL may estimate the position and the direction of the target vehicle 1-X shown in the image IMG. The machine learning model MDL may use a neural network. The machine learning model MDL is generated in advance through learning and stored in the storage device 120. Then, the position estimation unit 160 estimates the position and the direction of the target vehicle 1-X by using the machine learning model MDL. The position estimation unit 160 may use information regarding a vehicle specification (e.g., a vehicle length, a vehicle width, a wheel base, and the like) of the target vehicle 1-X as supplementary information.

As a modification example, the position estimation unit 160 may first extract a common feature point (for example, a tire) common to various vehicles 1 from the target vehicle 1-X by using a common machine learning model and then calculate a rough position of the target vehicle 1-X based on the common feature point. Thereafter, the position estimation unit 160 may extract a unique feature point unique to the vehicle type of the target vehicle 1-X by using a machine learning model MDL trained for each vehicle type and then calculate a detailed position of the target vehicle 1-X based on the unique feature point.

Infrastructure camera information includes installation information and performance information of the infrastructure camera CAM. The installation information includes an installation position and an installation direction of the infrastructure camera CAM in the absolute coordinate system (i.e., the world coordinate system). The performance information includes an angle of view, a focal length, and the like of the infrastructure camera CAM. The infrastructure camera information for each infrastructure camera CAM is registered in the vehicle management system 100 in advance. Alternatively, the infrastructure camera information may be provided from the infrastructure camera CAM.

The position estimation unit 160 acquires the infrastructure camera information regarding the infrastructure camera CAM that has captured the image IMG showing the target vehicle 1-X. Then, the position estimation unit 160 converts the position of the target vehicle 1-X in the image IMG into a position of the target vehicle 1-X in the absolute coordinate system by using the infrastructure camera information. Alternatively, the position estimation unit 160 converts the position and the direction of the target vehicle 1-X in the image IMG into a position and a direction of the target vehicle 1-X in the absolute coordinate system by using the infrastructure camera information.

In this manner, it is possible to estimate the position and the direction of the target vehicle 1-X shown in the image IMG captured by the infrastructure camera CAM. Using the machine learning model MDL makes it possible to accurately estimate the position and the direction of the target vehicle 1-X.

### 2-2. Comparative Example

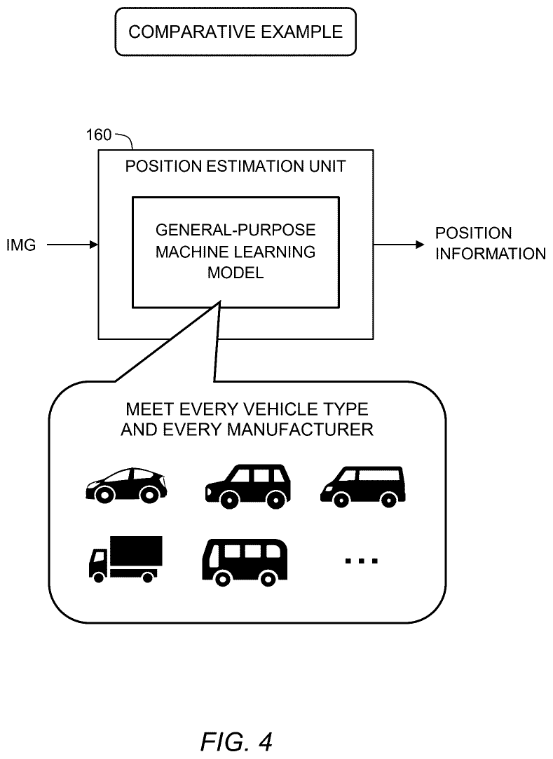

FIG. 4 is a conceptual diagram for explaining a comparative example. In the comparative example, the machine learning model MDL included in the position estimation unit 160 is a general-purpose machine learning model that meets (supports) every vehicle type and every manufacturer. However, it takes a lot of work and a huge cost to create such the general-purpose machine learning model that can meet all vehicle types and all manufacturers with sufficient accuracy. In addition, it is necessary to update such the general-purpose machine learning model each time a new vehicle type is released. This also leads to increase in works and costs.

### 2-3. Target-Specialized Vehicle Position Estimation Process

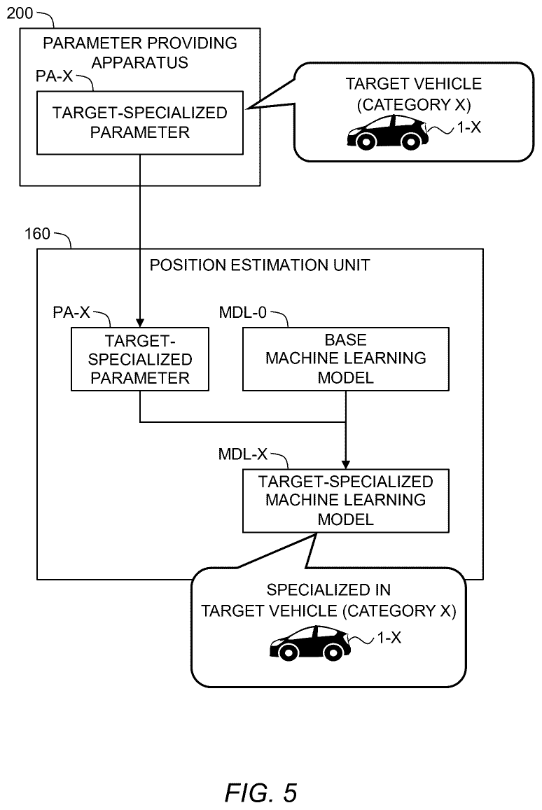

FIG. 5 is a block diagram for explaining the vehicle position estimation process according to the present embodiment.

A parameter of the machine learning model MDL defines characteristics of the machine learning model MDL. For example, the parameter of the machine learning model MDL includes weights representing strength of coupling between nodes in the neural network.

A target-specialized parameter PA-X is the parameter of the machine learning model MDL that has been trained with a focus on a category X of the target vehicle 1-X. The category X is exemplified by a vehicle type, a manufacturer, and the like. According to the present embodiment, the target-specialized parameter PA-X specialized in (dedicated to) the category X is prepared in advance. An example of generating the target-specialized parameter PA-X will be described later in Section 4.

A parameter providing apparatus 200 retains the target-specialized parameter PA-X prepared in advance. The parameter providing apparatus 200 is able to communicate with the vehicle management system 100 and provides the target specialized parameter PA-X to the vehicle management system 100. The parameter providing apparatus 200 may be the in-vehicle device 10 mounted on the target vehicle 1-X or a predetermined management server.

According to the present embodiment, the position estimation unit 160 includes a base machine learning model MDL-0. The base machine learning model MDL-0 has the same structure as the machine learning model MDL. The base machine learning model MDL-0 may be the machine learning model MDL before training (learning). The position estimation unit 160 acquires the target specialized parameter PA-X specialized in the category X of the target vehicle 1-X from the parameter providing apparatus 200. The position estimation unit 160 applies the target-specialized parameter PA-X to the base machine learning model MDL-0 to acquire a target-specialized machine learning model MDL-X specialized in the category X. In other words, the position estimation unit 160 replaces the parameter of the base machine learning model MDL-0 with the target-specialized parameter PA-X to acquire the target-specialized machine learning model MDL-X specialized in the category X. In still other words, the position estimation unit 160 acquires the target-specialized machine learning model MDL-X specialized in the category X by combining the base machine learning model MDL-0 and the target-specialized parameter PA-X.

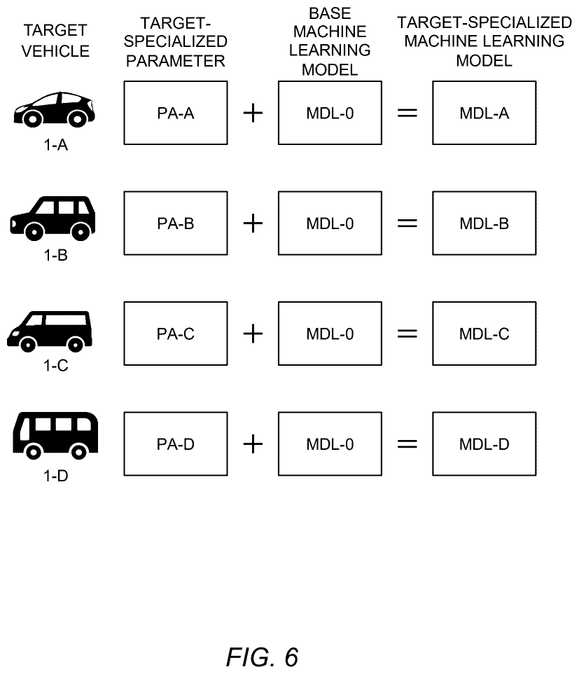

FIG. 6 shows a variety of target-specialized machine learning models MDL-X. For example, a target-specialized machine learning model MDL-A specialized in a category A can be obtained by combining a target-specialized parameter PA-A of the category A and the base machine learning model MDL-0. A target-specialized machine learning model MDL-B specialized in a category B can be obtained by combining a target-specialized parameter PA-B of the category B and the base machine learning model MDL-0. The target-specialized machine learning model MDL-A specialized in the category A and the target-specialized machine learning model MDL-B specialized in the category B are different from each other. The target-specialized machine learning model MDL-A specialized in the category A is able to estimate at least the position of the target vehicle 1-A of the category A with high accuracy, but is not necessarily able to estimate the position of the target vehicles of the other categories with high accuracy. Similarly, the target-specialized machine learning model MDL-B specialized in the category B is able to estimate at least the position of the target vehicle 1-B of the category B with high accuracy, but is not necessarily able to estimate the positions of the target vehicles of the other categories with high accuracy.

According to the present embodiment, the position estimation unit 160 estimates the position and the direction of the target vehicle 1-X by using the target-specialized machine learning model MDL-X specialized in the category X. It is thus possible to estimate the position and the direction of the target vehicle 1-X with high accuracy.

It should be noted that the position estimation unit 160 may delete at least one of the target-specialized parameter PA-A and the target-specialized machine learning model MDL-X after the position of the target vehicle 1-X is estimated. The position estimation unit 160 may delete both the target-specialized parameter PA-A and the target-specialized machine learning model MDL-X. This makes it possible to reduce the amount of use of the storage device 120 of the vehicle management system 100.

### 2-4. Effects

As described above, according to the present embodiment, the target-specialized parameter PA-X specialized in the category X of the target vehicle 1-X is acquired from the parameter providing apparatus 200. Applying the target-specialized parameter PA-X to the base machine learning model MDL-0 makes it possible to acquire the target-specialized machine learning model MDL-X specialized in the category X of the target vehicle 1-X. Then, the position of the target vehicle 1-X is estimated based on the target-specialized machine learning model MDL-X. It is thus possible to estimate the position of the target vehicle 1-X with high accuracy.

Further, according to the present embodiment, a general-purpose machine learning model that can meet all categories is not necessary. Since it is not necessary to generate or update a general-purpose machine learning model that can meet all categories, works and costs are significantly reduced.

After the position of the target vehicle 1-X is estimated, at least one of the target-specialized parameter PA-X and the target-specialized machine learning model MDL-X may be deleted from the vehicle management system 100. This makes it possible to reduce the amount of use of the storage device 120 of the vehicle management system 100.

### 3. Example of Parameter Providing Apparatus

### 3-1. First Example

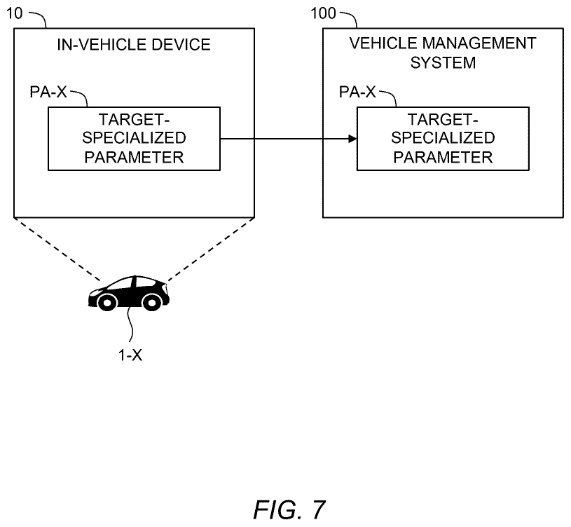

FIG. 7 is a block diagram for explaining a first example of the parameter providing apparatus 200. In the first example, the parameter providing apparatus 200 is the in-vehicle device 10 mounted on the target vehicle 1-X. The in-vehicle device 10 retains the target-specialized parameter PA-X regarding the category X of the target vehicle 1-X. For example, the target-specialized parameter PA-X is stored in an ECU (Electronic Control Unit) of the in-vehicle device 10. The target specialized parameter PA-X may be stored in the ECU by the manufacturer at the time of manufacturing the target vehicle 1-X.

The vehicle management system 100 communicates with the in-vehicle device 10 of the target vehicle 1-X to acquire the target-specialized parameter PA-X from the in-vehicle device 10. Then, the vehicle management system 100 estimates the position and the direction of the target vehicle 1-X by using the target-specialized parameter PA-X.

According to the first example, the target specialized parameter PA-X specialized in the target vehicle 1-X is obtained from the target vehicle 1-X itself, which is efficient.

### 3-2. Second Example

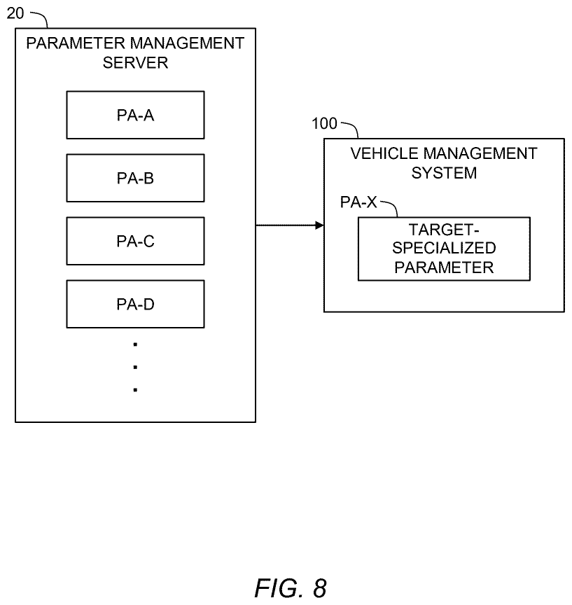

FIG. 8 is a block diagram for explaining a second example of the parameter providing apparatus 200. In the second example, the parameter providing apparatus 200 is a parameter management server 20. The parameter management server 20 retains a plurality of types of target-specialized parameters PA-A, PA-B, and the like. The plurality of types of target-specialized parameters PA-A, PA-B, and the like are respective parameters of the machine learning models MDL respectively trained with focuses on a plurality of categories A, B, and the like.

The vehicle management system 100 acquires information of the category X of the target vehicle 1-X from the target vehicle 1-X. Further, the vehicle management system 100 communicates with the parameter management server 20, and selectively acquires the target specialized parameter PA-X specialized in the category X of the target vehicle 1-X from among the plurality of types of target specialized parameters PA-A, PA-B, and the like. Then, the vehicle management system 100 estimates the position and the direction of the target vehicle 1-X by using the target-specialized parameter PA-X.

According to the second example, it is possible to collectively manage the plurality of types of target specialized parameters PA-A, PA-B, and the like. Further, it is possible to reduce processing load on the target vehicle 1-X.

### 4. Generation of Target-Specialized Parameter

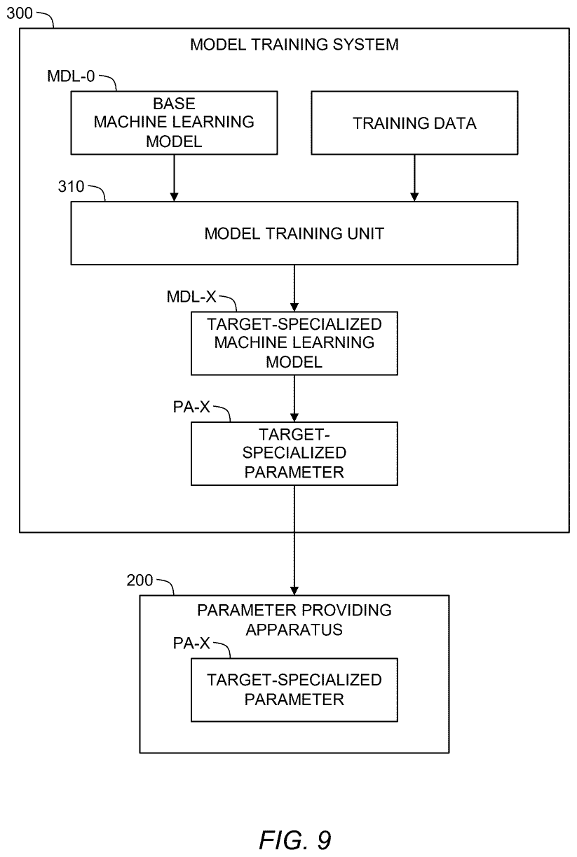

FIG. 9 is a block diagram for explaining the generation of the target-specialized parameter PA-X. A model training system 300 acquires training data dedicated to the category X. The training data dedicated to the category X include a large number of combinations of training image showing a vehicle 1 of the category X and position information of the vehicle 1. For example, the training image is obtained by imaging one or more vehicles 1 of the category X from various directions. As another example, the training image may be generated by simulation using CAD data of the vehicle 1 of the category X. The position information may be acquired by actual measurement or may be calculated by simulation.

The model training system 300 retains the base machine learning model MDL-0. The model training unit 310 trains the base machine learning model MDL-0 by using the training data dedicated to the category X, thereby generating the target-specialized machine learning model MDL-X specialized in (dedicated to) the category X. The parameter of the generated target-specialized machine learning model MDL-X is the target-specialized parameter PA-X. The model training system 300 provides the generated target-specialized parameter PA-X to the parameter providing apparatus 200.

It should be noted that the entity that generates the target-specialized parameter PA-X is arbitrary. For example, a vehicle manufacturer that manufactures the vehicle 1 of the category X may generate the target-specialized parameter PA-X regarding the category X. Then, the vehicle manufacturer may store information of the target-specialized parameter PA-X in the in-vehicle device 10 (see FIG. 7) of the manufactured vehicle 1. As another example, a business operator that provides the AVP service may generate a plurality of types of target-specialized parameters PA-A, PA-B, and the like. Then, the business operator may store the plurality of types of target specialized parameters PA-A, PA-B, and the like in the parameter management server 20 (see FIG. 8).

There may be a case where a user of the vehicle 1 customizes the vehicle 1. For example, the user may attach an additional decorative part to the user's vehicle 1. In this case, the target-specialized parameter PA-X specialized in the vehicle 1 of the user may be generated. For example, the user may provide the model training system 300 with information on the category X of the user's vehicle 1 and information indicating an appearance of the customized vehicle. The information from which the vehicle appearance can be recognized is, for example, a set of images obtained by imaging the customized vehicle 1 from various directions. The model training system 300 performs the above-described training process based on the information received from the user. As a result, the target-specialized machine learning model MDL-X trained with a focus not only on the category X of the user's vehicle 1 but also the vehicle appearance customized by the user is obtained. The parameter of the target-specialized machine learning model MDL-X thus obtained is the target-specialized parameter PA-X specialized in the vehicle 1 of the user. The model training system 300 may provide the target specialized parameter PA-X specialized in the vehicle 1 of the user to the in-vehicle device 10 (the parameter providing apparatus 200) of the vehicle 1 of the user. In this manner, it is possible to cope with customization of the user of the vehicle 1.

### 5. Concrete Example of Vehicle Management

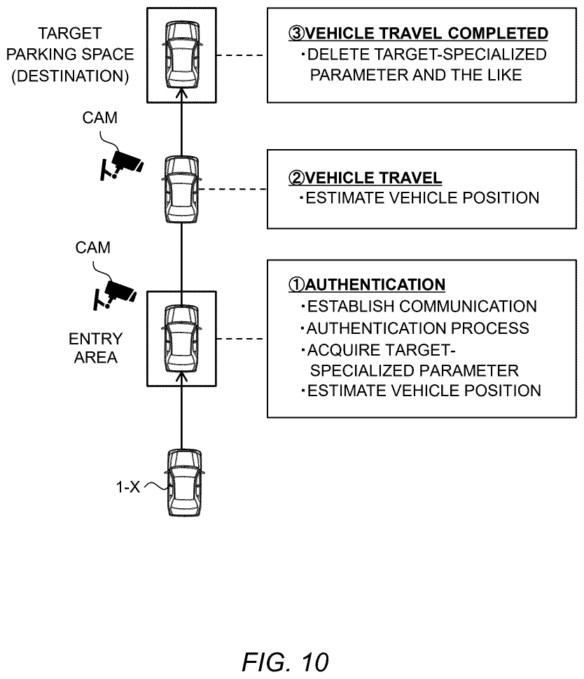

FIG. 10 is a conceptual diagram for explaining a concrete example of vehicle management by the vehicle management system 100. Here, a scene in which the automated valet parking described in FIG. 2 is performed will be considered. The predetermined area is a parking lot. In addition, it is assumed that the in-vehicle device 10 of the target vehicle 1-X holds the target-specialized parameter PA-X (see FIG. 7).

The target vehicle 1-X arrives at the entry area of the parking lot and stops. An infrastructure camera CAM is installed at the entry area. The vehicle management system 100 acquires the image IMG captured by the infrastructure camera CAM. The target vehicle 1-X is shown in the image IMG.

The vehicle management system 100 performs an authentication process. More specifically, the vehicle management system 100 establishes a communication with the in-vehicle device 10 of the target vehicle 1-X. Moreover, the vehicle management system 100 authenticates the target vehicle 1-X. At the stage of the authentication process, the vehicle management system 100 communicates with the in-vehicle device 10 of the target vehicle 1-X and acquires the target-specialized parameter PA-X from the in-vehicle device 10. Then, the vehicle management system 100 estimates the position and the like of the target vehicle 1-X on the basis of the acquired target-specialized parameter PA-X and the image IMG.

The vehicle management system 100 manages traveling of the target vehicle 1-X in the parking lot based on the estimated position of the target vehicle 1-X and the like. For example, after the authentication process is completed, the vehicle management system 100 allocates an available parking space to the target vehicle 1-X. The allocated available parking space is the target parking space (i.e., the destination). Further, the vehicle management system 100 sets a target trajectory (target route) from the current position of the target vehicle 1-X to the target parking space. The vehicle management system 100 issues an entry instruction to the in-vehicle device 10. In response to the entry instruction, the in-vehicle device 10 causes the target vehicle 1-X to travel to the target parking space in accordance with the target trajectory.

As described above, at the authentication stage before the target vehicle 1-X starts traveling in the parking lot (i.e., the predetermined area), the vehicle management system 100 acquires the target-specialized parameter PA-X and estimates the position of the target vehicle 1-X. Therefore, after the authentication is completed, the target vehicle 1-X is able to quickly start traveling.

The target vehicle 1-X traveling toward the target parking space may be imaged by the infrastructure camera CAM. The vehicle management system 100 acquires the image IMG showing the target vehicle 1-X during traveling from the infrastructure camera CAM. The vehicle management system 100 estimates the position and the like of the target vehicle 1-X during traveling based on the target-specialized parameter PA-X and the image IMG. The vehicle management system 100 may check whether the target vehicle 1-X is traveling along the target trajectory based on the estimated position. The vehicle management system 100 may remotely control the target vehicle 1-X to make the target vehicle 1-X travel to the target parking space in accordance with the target trajectory.

The target vehicle 1-X arrives at the target parking space and stops. After the traveling of the target vehicle 1-X in the parking lot is completed, the vehicle management system 100 may delete at least one of the target-specialized parameter PA-X and the target-specialized machine learning model MDL-X regarding the target vehicle 1-X. The vehicle management system 100 may delete both the target-specialized parameter PA-A and the target-specialized machine learning model MDL-X. This makes it possible to reduce the amount of use of the storage device 120 of the vehicle management system 100.

What is claimed is:

1. A vehicle management system that manages a vehicle in a predetermined area,
the vehicle management system comprising:
processing circuitry; and
a storage configured to store a machine learning model for estimating a position of a vehicle shown in an image, wherein
the processing circuitry is configured to:
acquire a target-specialized parameter from a parameter providing apparatus, the target-specialized parameter being a parameter of the machine learning model trained with a focus on a category of a target vehicle;
apply the target-specialized parameter to the machine learning model stored in the storage to acquire a target-specialized machine learning model specialized in the category of the target vehicle;
acquire an image captured by a camera installed in the predetermined area and showing the target vehicle; and
estimate a position of the target vehicle based on the image and the target-specialized machine learning model.

2. The vehicle management system according to claim 1, wherein
the processing circuitry is further configured to delete at least one of the target-specialized parameter and the target-specialized machine learning model from the vehicle management system after estimating the position of the target vehicle.

3. The vehicle management system according to claim 1, wherein
the processing circuitry is further configured to manage traveling of the target vehicle in the predetermined area based on the estimated position of the target vehicle.

4. The vehicle management system according to claim 3, wherein
the processing circuitry is further configured to acquire the target-specialized parameter from the parameter providing apparatus before the target vehicle starts traveling in the predetermined area.

5. The vehicle management system according to claim 3, wherein
the processing circuitry is further configured to delete at least one of the target-specialized parameter and the target-specialized machine learning model from the vehicle management system after the traveling of the target vehicle in the predetermined area is completed.

6. The vehicle management system according to claim 1, wherein
the parameter providing apparatus is an in-vehicle device mounted on the target vehicle, and
the processing circuitry is further configured to communicate with the in-vehicle device to acquire the target-specialized parameter from the in-vehicle device.

7. The vehicle management system according to claim 6, wherein
the processing circuitry is further configured to acquire the target-specialized parameter from the in-vehicle device at an authentication stage of the target vehicle.

8. The vehicle management system according to claim 1, wherein
the parameter providing apparatus retains a plurality of types of target-specialized parameters that are respective parameters of machine learning models respectively trained with focuses on a plurality of categories, and
the processing circuitry is further configured to selectively acquire the target-specialized parameter specialized in the category of the target vehicle from among the plurality of types of target-specialized parameters.

9. The vehicle management system according to claim 1, wherein
the target-specialized parameter is a parameter of the machine learning model trained with a focus not only on the category of the target vehicle but also on a vehicle appearance customized by a user.

10. A vehicle management method for managing a vehicle in a predetermined area by a computer,
the vehicle management method comprising:
acquiring a machine learning model for estimating a position of a vehicle shown in an image;
acquiring a target-specialized parameter from a parameter providing apparatus, the target-specialized parameter being a parameter of the machine learning model trained with a focus on a category of a target vehicle;
applying the target-specialized parameter to the machine learning model to acquire a target-specialized machine learning model specialized in the category of the target vehicle;
acquiring an image captured by a camera installed in the predetermined area and showing the target vehicle; and
estimating a position of the target vehicle based on the image and the target-specialized machine learning model.
